(19) United States
(12) Patent Application Publication
(10) Pub. No.: US 2006/0183509 A1
(43) Pub. Date: Aug. 17, 2006

(54) DC power source for an accessory of a portable communication device

(76) Inventor: Shuyong Shao, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/059,155

(22) Filed: Feb. 16, 2005

(51) Int. Cl. H04M 1/00; H04B 1/38

(52) U.S. Cl. 455/572; 455/550.1

(57) ABSTRACT

An accessory (102) for a portable communication device (104) includes audio input ports (134) for receiving a differential audio signal having a DC bias (114), a speaker (116) coupled to the audio input ports, and accessory electronics (124) powered by the DC bias. The use of the DC bias of the differential audio signal (114) as a power source enhances the power source capability of the accessory (102).

### FIELD OF THE INVENTION

The present invention relates generally to portable communication devices and more specifically to power sources used to operate these devices.

### BACKGROUND OF THE INVENTION

Many portable communication devices, such as portable radios, cell phones and the like, are used in conjunction with accessories, such as remote speakers, remote speaker-microphones, and headsets to name a few. With the advent of miniaturization, additional features and functionality are being incorporated into accessories, and thus additional circuitry is needed. Many of these accessories utilize a power source from the portable communication device. Typically, power is sourced through a supply line from the communication device's side connector or some other interface. The maximum current from the communication device must sometimes be limited, such as by an internal resistor and diode. For example, for a 6 volt battery voltage, the accessory supply line may be limited to 2.6 volts with a 50 mA sourcing capability due to internal impedances. This voltage and current source capability may not be sufficient to power all of the features and functionality that designers would like to incorporate into the accessories.

Accordingly, there is a need to enhance current sourcing capability while maintaining voltage level for accessories used in combination with portable communication devices.

### BRIEF DESCRIPTION OF THE FIGURES

A preferred embodiment of the invention is now described, by way of example only, with reference to the accompanying figures in which:

FIG. is a block diagram of an apparatus for supplying power to an accessory of a portable communication device in accordance with the present invention; and

FIG. 2 illustrates an accessory formed in accordance with the present invention coupled to a portable communication device.

### DETAILED DESCRIPTION OF THE PREFERRED EMBODIMENT

FIG. 1 shows an apparatus 100 for supplying power to an accessory 102 of a portable communication device 104 in accordance with the present invention. The portable communication device 104 may be a portable radio, cell phone or the like which includes a controller 106, receiver 108 and transmitter 110. Receiver 108 includes an audio power amplifier 112 for generating a differential audio signal having a DC bias 114. Accessory 102 may be a speaker-microphone, headset or other accessory having audio output capability, externally coupled to the communication device. Accessory 102 includes a speaker 116 for receiving the differential audio signal 114. Accessory 102 further includes a controller 118 and accessory circuitry 120, shown divided into primary and second accessory circuitry 122, 124 respectively.

Accessory 102 is coupled to portable communication device 104 via interface 126, such as a radio side connector, cable or other interconnect known in the art. Interface 126 couples data I/O lines 128, supply (B+) 130 and GND 132 to the accessory 102, with supply preferably powering the primary circuitry 122, either directly and/or via controller 118. Interface 126 couples the differential output signal having DC bias 114 to input ports 134 through to speaker 116. In accordance with the present invention, the differential audio output signal having a DC bias 114 is coupled through control circuits 118 and used to power the accessory's secondary circuitry 124. Control circuits 118 are used to filter out and regulate a DC output 136 from the differential audio signal 114. Thus, accessory 102 includes differential audio input ports 134 for receiving the differential audio signal having a DC bias 114; a speaker 116 coupled to the audio input ports; and accessory electronics 124 powered by the DC bias. The DC bias of the differential audio signal 114 can operate as either a primary or secondary power source for the accessory 102. Thus, the accessory's primary circuits 122 may be powered by a supply line, B+, coming from the portable communication device 104 while secondary circuitry 124 is powered by the DC bias of the differential audio signal 114.

The differential audio signal's DC output 136 is approximately half that of supply, (B+) 130, and can source up to a predetermined current level to secondary circuits 124 without distorting the audio. Secondary circuitry utilizing current levels lower than the predetermined limit can now be powered by the DC bias of the differential audio signal 114 without impacting the audio quality of the accessory 102. For example, a typical two-way portable radio having a 7 volt supply (B+) may have an audio power amplifier rating of 1 watt (W). If the speaker line_can supply 100 mA with 0.5 W rated audio output, then the secondary circuitry can load 50 mA at 3.75 volts while maintaining a 0.5 W audio output without degrading distortion. The resulting benefit is that two supply sources can now be used simultaneously without degrading the audio. The use of the DC bias of the differential audio signal enhances the accessory's ability to provide multiple power sources for increased features and functionality

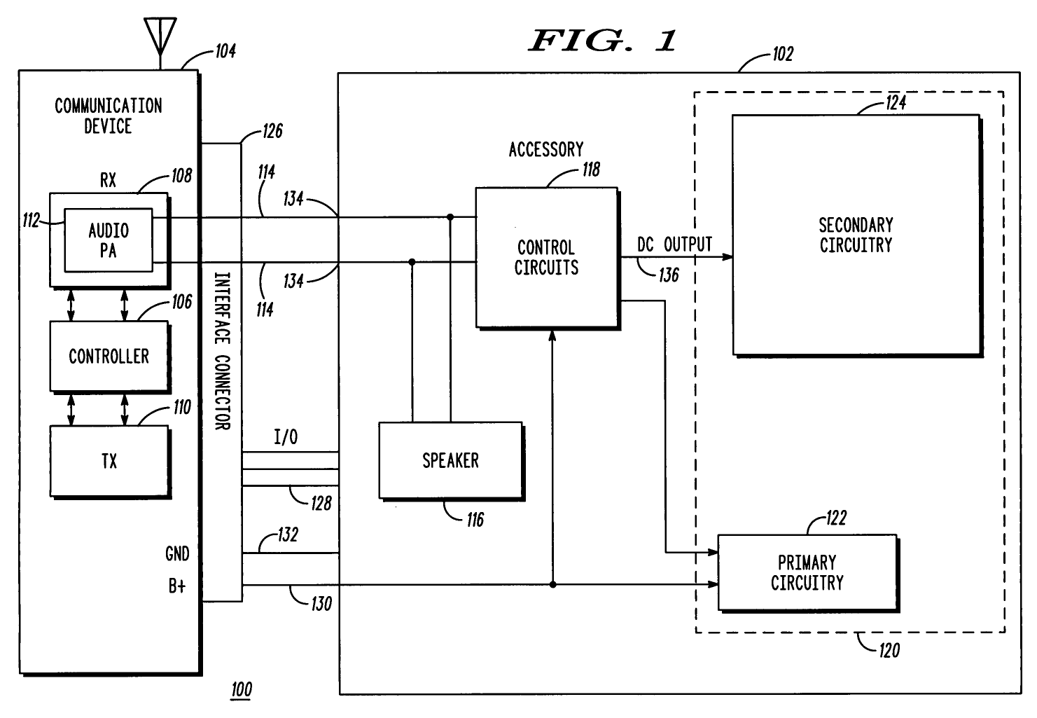

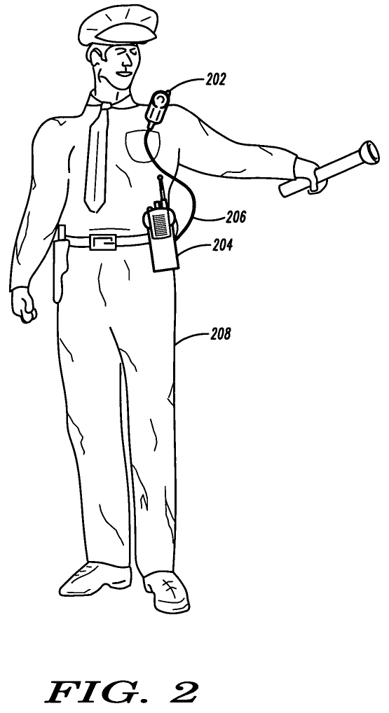

FIG. 2 shows an accessory formed in accordance with the present invention coupled to a portable communication device. The accessory 202, embodied as a remote speaker-microphone, is coupled to the portable communication device 204, shown here as a portable radio, via an interface 206, shown here as a cable, and worn by a user 208. In accordance with the present invention, the interface 206 couples a differential audio output having a DC bias, generated by an audio amplifier of the communication device 204, to the accessory 202. Accessory 202 includes accessory circuitry powered by the DC bias of the differential audio output.

The apparatus for powering an accessory in accordance with the present invention provides the advantage of additional supply capability without having to add interface interconnections. The use of the existing audio power amplifier lines being used to source limited power thus increases the ability to add functionality and features to accessories without increasing the size of the accessory.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

What is claimed is:

1. An apparatus for supplying power to a remote accessory of a portable communication device, comprising:
at the portable communication device;
an audio power amplifier generating a differential audio output having a DC bias;
an interface coupling the differential audio output to the accessory; at the accessory:
accessory circuitry being powered by the DC bias of the differential audio output.

2. The apparatus of claim 1, wherein the accessory is a remote speaker.

3. The apparatus of claim 1, wherein the accessory is a remote speaker-microphone.

4. The apparatus of claim 1, wherein the accessory is a cellular phone.

5. The apparatus of claim 1, wherein the accessory is a headset.

6. An accessory for a portable communication device, comprising:
audio input ports for receiving a differential audio signal having a DC bias;
a speaker coupled to the audio input ports; and
accessory electronics powered by the DC bias.

7. The accessory of claim 6, further comprising a controller and regulator for controlling and regulating the DC bias to the accessory electronics while maintaining audio quality.

8. An accessory for a communication device, comprising:
a primary supply input for receiving a first power source from the communication device for powering a first set of accessory circuitry; and
a secondary supply input for receiving a differential audio signal having a DC bias from the communication device for powering a second set of accessory circuitry.
